(19) United States
(12) Patent Application Publication
(10) Pub. No.: US 2018/0020150 A1
(43) Pub. Date: Jan. 18, 2018

(54) CONTROL APPARATUS, IMAGE CAPTURING APPARATUS, CONTROL METHOD, AND STORAGE MEDIUM

(71) Applicant: CANON KABUSHIKI KAISHA, Tokyo (JP)

(72) Inventor: Shohei Tozawa, Kawasaki-shi (JP)

(21) Appl. No.: 15/645,246

(22) Filed: Jul. 10, 2017

(30) Foreign Application Priority Data
Jul. 15, 2016 (JP) 2016-139980

(51) Int. Cl. H04N 5/232; H04N 5/378; G02B 3/00

(52) U.S. Cl. CPC H04N 5/23212; H04N 5/378; G02B 3/0056

(57) ABSTRACT

A control apparatus includes a signal acquirer configured to acquire first pair signals for a focus detection from a first area on an image sensor, and second pair signals for a focus detection from a second area on an AF sensor, and a calculator configured to calculate a defocus amount using the first pair signals or the second pair signals based on the first area on the image sensor and the second area on the AF sensor.

### BACKGROUND OF THE INVENTION

### Field of the Invention

The present invention relates to an image capturing apparatus configured to provide a focus detection using an output signal from an image sensor.

### Description of the Related Art

Japanese Patent Laid-Open No. (“JP”) 2012-198478 discloses an image capturing apparatus configured to provide a focus detection by calculating a phase difference between a pair of images formed by a pair of light fluxes that have passed different areas in an exit pupil in an image capturing optical system, through a focus detection dedicated device (AF sensor) different from an image sensor. JP 2012-198478 discloses a configuration that determines whether in-focus information is to be displayed, based on a focus detection result obtained by the AF sensor.

JP 2014-157338 discloses an image capturing apparatus that includes an image sensor having pixels configured to obtain a focus detecting signal and provides a focus detection by utilizing this signal. The image capturing apparatus disclosed in JP 2014-157338 is configured to read a plurality of types of data, such as focus detection pixel data and imaged pixel data, from the image sensor. JP 2014-157338 discloses a method for adding and reading pixel signals in a horizontal or vertical direction so as to shorten a read time.

JP 2005-128156 discloses a method for setting a position and a focus frame of image data to be focused, based on face information in an object, for detecting an in-focus point position for each focus frame, and for determining an in-focus point position used for image capturing among the detected in-focus point positions.

In general, a plurality of pixels that serves as the AF sensor are discretely arranged due to a layout limitation on the sensor chip. Therefore, JP 2012-198478 cannot provide an accurate focus detection unless there is a main object in a focus detectable area for the AF sensor.

### SUMMARY OF THE INVENTION

The present invention provides a control apparatus, an image capturing apparatus, a control method and a storage medium, which can provide an accurate focus detection.

A control apparatus according to one aspect of the present invention includes a signal acquirer configured to acquire a pair of first signals (first pair signals) for a focus detection from a first area on an image sensor, and a pair of second signals (second pair signals) for a focus detection from a second area on an AF sensor, and a calculator configured to calculate a defocus amount using the first pair signals or the second pair signals based on the first area on the image sensor and the second area on the AF sensor.

Further features of the present invention will become apparent from the following description of exemplary embodiments with reference to the attached drawings.

### BRIEF DESCRIPTION OF THE DRAWINGS

FIG. 1 is a block diagram of an image capturing apparatus according to each embodiment.

FIGS. 2A and 2B are circuit diagrams of a pixel on an image sensor according to each embodiment.

FIGS. 3A to 3D are schematic diagrams of a focus detection of a phase difference detection method by the image sensor according to each embodiment.

FIG. 4 is a schematic diagram of an AF sensor according to each embodiment.

FIGS. 5A and 5B are flowcharts of a focus detection according to a first embodiment.

FIGS. 6A to 6D are illustrative images in the focus detection according to the first embodiment.

FIG. 7 is a flowchart of a focus detection according to a second embodiment.

FIGS. 8A to 8F are illustrative images in the focus detection according to the second embodiment.

FIGS. 9A-9C are timing charts in a read operation by the image sensor according to each embodiment.

FIG. 10 is an explanatory view of image data in each embodiment.

FIG. 11 is a timing chart of a focus detection in each embodiment.

FIGS. 12A and 12B are explanatory views of a read area in the second embodiment.

### DESCRIPTION OF THE EMBODIMENTS

Referring now to the accompanying drawings, a description will be given of embodiments of the present invention.

### First Embodiment

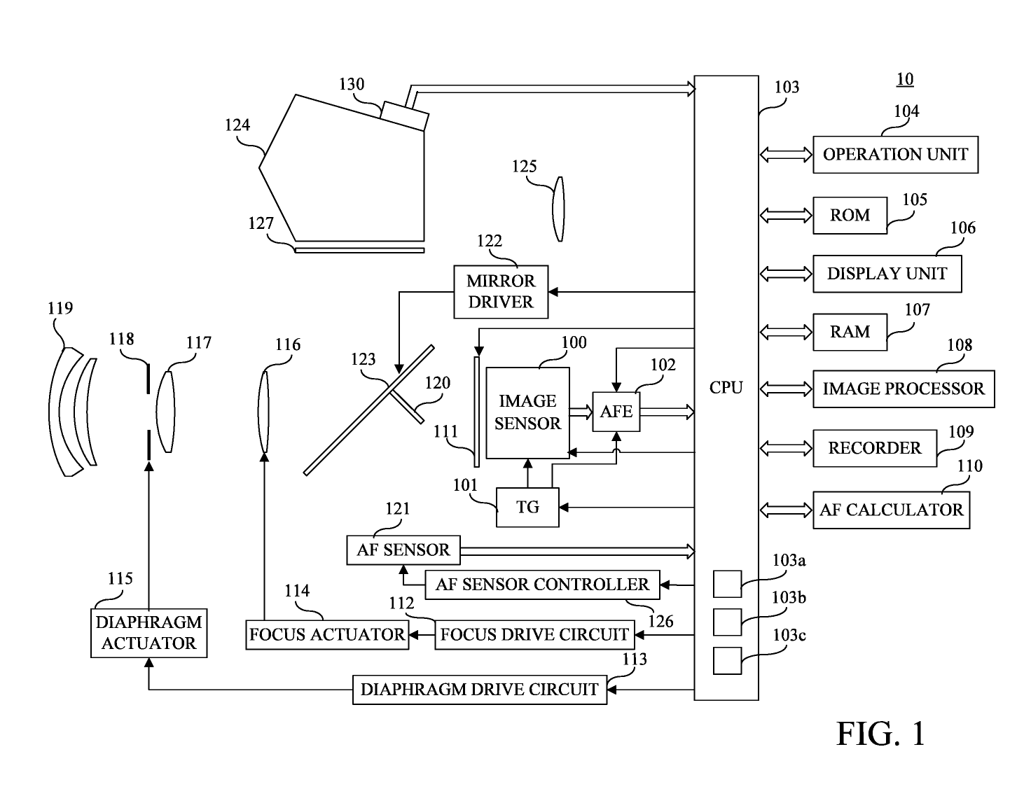

Referring now to FIG. 1, a description will be given of an image capturing apparatus according to a first embodiment of the present invention. FIG. 1 is a block diagram of an image capturing apparatus 10 according to this embodiment.

An image sensor 100 or an imaging sensor, such as a CMOS (complementary metal oxide semiconductor) image sensor, photoelectrically converts an object image (optical image) formed by the image capturing optical system into an electric signal. The image sensor 100 outputs a pixel signal (focus detection signal) for a focus detection through a first reading operation, which will be described alter. The image sensor 100 outputs a pixel signal (image signal) so as to obtain an image (captured image) through a second reading operation. The image sensor 100 is controlled by a CPU 103, which will be described later, and captures a still or motion image. In this embodiment, the image capturing apparatus 10 includes an image capturing apparatus body (camera body) that includes an image sensor 100, and an image capturing optical system (lens apparatus) that can be attached to and detached from the image capturing apparatus body. This embodiment is not limited to this example, and is applicable to an image capturing apparatus in which the image capturing body is integrated with the image capturing optical system. A timing generator (TG) 101 controls a drive timing of each of the image sensor 100 and an AFE 102, which will be described later.

The CPU 103 is a controller (control apparatus) configured to integrally control the image capturing apparatus 10. The CPU 103 executes a program for controlling each component in the image capturing apparatus 10. The CPU 103 calculates a position coordinate of a main object based on an image (image information) obtained from an AE sensor 130, which will be described later, and determines a pixel area to be read from the image sensor 100 in the first read operation and necessary for a calculation by an AF calculator 110, which will be described later, based on a calculated result.

In this embodiment, the CPU 103 includes a signal acquirer 103a, a calculator 103b, and an area acquirer 103c. The signal acquirer 103a obtains first pair signals for a focus detection from a first area (focus detecting area) on the image sensor 100, and second pair signals for a focus detection from a second area (focus detection point) on an AF sensor 121. The calculator 103b calculates a defocus amount based on the first area on the image sensor 100 and the second area on the AF sensor 121 using the first pair signals or the second pair signals. The area acquirer 103c acquires an object area (face area) detected by an object detector (AE sensor 130).

The analog font end (AFE) 102 performs a digital conversion corresponding to a gain adjustment and a predetermined quantization bit for an analog image signal output from the image sensor 100. This embodiment arranges the TG 101 and the AFE 102 outside the image sensor 100, but the image sensor 100 may include at least one of the TG 101 and the AFE 102.

An operation unit 104 sets information to the CPU 103, such as an image capturing command and an image capturing condition. A ROM 105 stores a program to be loaded and executed by the CPU 103 for controls over operations of each component. The ROM 105 is a flash-ROM in this embodiment, but the present invention is not limited to this embodiment and may use another memory as long as the memory has an access speed enough high for the operation.

A display unit 106 displays captured still and motion images, a menu, etc. A RAM 107 serves as an image data storage unit configured to store image data digitally converted by the AFE 102 and image data processed by an image processor 108, which will be described later, and as a work memory when the CPU 103 operates as described later. This embodiment performs these functions with the RAM 107, but the present invention is not limited to this embodiment. The present invention is applicable to another memory as long as the memory has an access speed enough high for the operation.

The image processor 108 provides a correction, a compression, and another process for a captured still or motion image. The image processor 108 has an addition function of A image data and B image data, which will be described later, and a generation function of a still image and a motion image. A recorder 109 (recording medium) is a detachable flash memory for recording still image data and motion image data. The recorder 109 is, but not limited to, a flash memory in this embodiment. The recorder 109 may use a nonvolatile memory, a hard disk drive, etc. in which data can be written. The image capturing apparatus 10 may include the recorder 109.

A main mirror 123 reflects an object image (optical image) formed by the image capturing optical system. The main mirror 123 introduces the optical image to a sub mirror 120, which will be described later, with a predetermined transmittance, and to a pentaprism 124 and an AE sensor 130, which will be described later, with a predetermined reflectance. The sub mirror 120 reflects the object image (optical image) formed by the image capturing optical system, and introduces it to an autofocus (AF) sensor 121, which will be described later. A mirror driver 122 is controlled by the CPU 103, and drives the main mirror 123 and the sub mirror 120.

The AF sensor 121 obtains (outputs) a pixel signal (second pair signals) for a focus detection. The AF sensor 121 receives light from the sub mirror 120 that has moved down in accordance with the operation of the mirror driver 122, and photoelectrically convers the optical image into an electric signal. The AF sensor 121 includes a plurality of pairs of photoelectric conversion element rows (pixels), and a pair of optical element rows correspond to one focus detection point. The photoelectric conversion element rows are discretely arranged.

The optical image is formed on a focus glass 127 via the main mirror 123. The pentaprism 124 and an eyepiece lens 125 enable the optical image formed on the focus glass 127 to be observed. The AE sensor 130 obtains image information necessary for the CPU 103 to measure an exposure amount or to determine a main object. The focus glass 127, the pentaprism 124, and the AE sensor 130 receive light from the main mirror 123 that has moved down in accordance with the operation of the mirror driver 122.

An AF sensor controller 126 is controlled by the CPU 103 and controls a read operation by the AF sensor 121. The CPU 103 calculates the position coordinate of the main object based on the image information obtained from the AE sensor 130, and selects the focus detection point of the AF sensor 121 based on the calculated result. The AF sensor controller 126 controls the AF sensor 121 based on the focus detection point selected by the CPU 103.

The AF calculator 110 calculates a drive amount of a third lens unit 116 to be notified to the following focus drive circuit 112 using a pixel signal output from each of the image sensor 100 and the AF sensor 121. In other words, the AF calculator 110 can calculate the drive amount of the third lens unit 116 using any one of the pixel signal obtained from the image sensor 100 and the pixel signal obtained from the AF sensor 121.

A first lens unit 119 is disposed at a tip of the image capturing optical system (common optical system) and held movably back and force in the optical axis direction. A diaphragm (aperture stop) 118 adjusts a light quantity in image capturing by adjusting an aperture diameter. The diaphragm 118 and a second lens unit 117 integrally move back and forth in the optical axis direction, and realizes a magnification variable operation (zoom function) associated with a moving operation of the first lens unit 119. A third lens unit 116 (focus lens) adjusts a focal point for the image capturing optical system when moving back and forth in the optical axis direction. A focal plane shutter 111 adjusts an exposure value in capturing a still image. This embodiment adjusts the exposure value for the image sensor 100 using the focal plane shutter 111, but is not limited to this example. For example, the image sensor 100 may have an electronic shutter function, and adjust the exposure value with a control pulse.

A focus drive circuit 112 is a focus position changer configured to change a focus position of the optical system (image capturing optical system). The CPU 103 compares a calculated position coordinate of a main object, a focus detection position of the AF sensor 121 determined by the position coordinate, and a pixel area to be read in the first read operation from the image sensor 100 determined by the position coordinate with one another. The CPU 103 selects (determines) whether the lens (focus lens) is driven with the drive amount calculated using the pixel information (focus detection signal) of one of the AF sensor 121 and the image sensor 100, in accordance with the compared result. A focus actuator 114 is driven by a focus drive circuit 112, and provides focusing by moving back and forth the third lens unit 116 in the optical axis direction. A diaphragm drive circuit 113 controls an aperture in the diaphragm 118 by driving a diaphragm actuator 115. A focus detection apparatus in this embodiment includes the image sensor 100, the AF sensor 121, the AF calculator 110, and the CPU 103. The image capturing optical system in this embodiment includes the first lens unit 119, the diaphragm 118, the second lens unit 117, and the third lens unit 116.

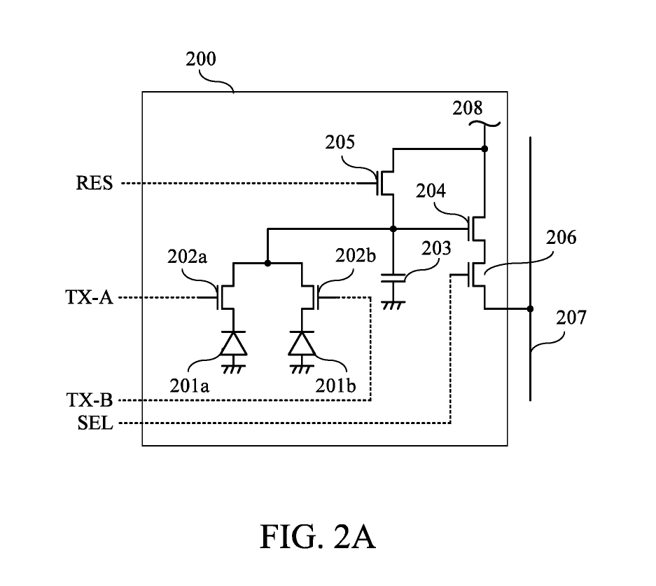

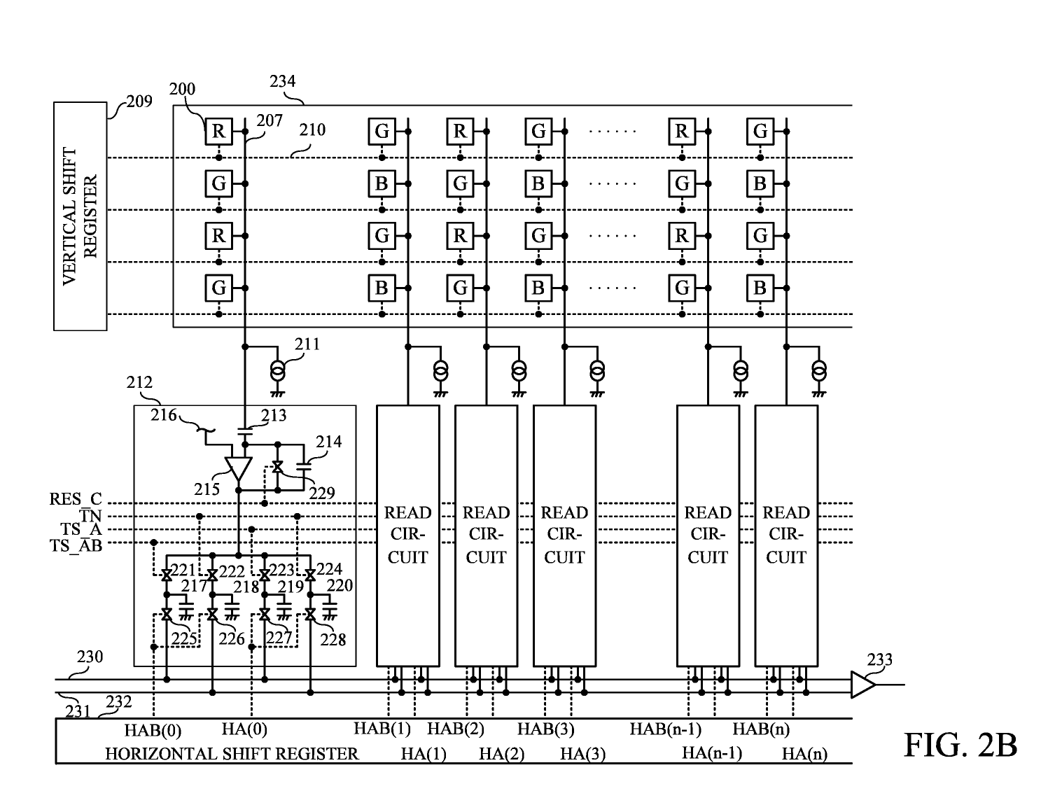

Referring now to FIGS. 2A and 2B, a description will be given of a configuration of the image sensor 100. FIGS. 2A and 2B are structural diagrams of the image sensor 100, FIG. 2A illustrates a circuit of a pixel 200 (unit pixel) on the image sensor 100, and FIG. 2B illustrates a read circuit in the image sensor 100. The image sensor 100 has a first photoelectric converter and a second photoelectric converter for one micro lens, and a plurality of micro lenses are two-dimensionally arranged.

As illustrated in FIG. 2A, the pixel 200 includes a photodiode 201a, (first photoelectric converter), a photodiode 201b (second photoelectric converter), transfer switches 202a and 202b, a floating diffusion 203, an amplifier 204, a reset switch 205, and a selection switch 206. Reference numeral 208 is a common power source configured to supply a reference voltage VDD. As described above, the image sensor 100 includes pixels (unit pixels) each having the first photoelectric converter and the second photoelectric converter. The number of photoelectric converters provided to each pixel is not limited to two as illustrated in FIG. 2A and each pixel may include two or more (such as four) photoelectric converters. In this embodiment, the first photoelectric converter or the second photoelectric converter may serves as a focus detection pixel, as described later. A sum signal of the first photoelectric converter and the second photoelectric converter is used to generate a captured image, as described later.

Each of the photodiodes 201a and 201b serves as a photoelectric converter configured to receive light that has passed the same micro lens (one micro lens), and to generate a signal charge corresponding to the received light amount. Each of the transfer switches 202a and 202b transfers electric charges generated by a corresponding one of the photodiodes 201a and 201b to the common floating diffusion 203. The transfer switches 202a and 202b are controlled by transfer pulse signals TX_A and TX_B. The floating diffusion 203 serves as a charge-voltage converter configured to temporarily store electric charges transferred from the photodiodes 201a and 201b, and to convert the stored electric charges into a voltage signal.

The amplifier 204 is a source follower MOS transistor, and outputs as a pixel signal a voltage signal that is based on the electric charges held in the floating diffusion 203. The reset switch 205 is controlled by a reset pulse signal RES, and resets the potential of the floating diffusion 203 to the reference voltage (potential) VDD 208. The selection switch 206 is controlled by a vertical selection pulse signal SEL, and outputs the pixel signal amplified by the amplifier 204 to a vertical output line 207.

A pixel area 234 illustrated in FIG. 2B includes a plurality of pixels 200 arranged in a matrix shape. For a simpler description, this embodiment arranges (n+1) pixels in a horizontal direction and four pixels in a vertical direction, but more pixels may be actually arranged in the vertical direction. The pixel 200 has one of a plurality of color filters (three colors or red, green and blue in this embodiment). In FIG. 2B, an illustrated R pixel has a red color filter and images red light, an illustrated G pixel has a green color filter and images green light, and an illustrated B pixel has a blue color filter and images blue light. Pixels with the three types of color filters are arranged in a Bayer arrangement.

A vertical shift register 209 sends a drive pulse through a common drive signal line 210 for each pixel in each column. One drive signal line 210 is illustrated for each column for simplicity, but a plurality of drive signal lines are actually connected for each column. The pixels 200 on the same row are connected to a common vertical output line 207, and a signal from each pixel is input to the common read circuit 212 via the vertical output line 207. A signal processed in a read circuit 212 is sequentially output to an output amplifier 233 by a horizontal shift register 232. Reference numeral 211 denotes a current source load connected to the vertical output line 207.

Next follows a description of a concrete circuit configuration of the read circuit 212. Reference numeral 213 denotes a clamp capacitor C0, reference numeral 214 denotes a feedback capacitor Cf, reference numeral 215 denotes an operational amplifier, reference numeral 216 denotes a reference voltage source configured to supply a reference voltage Vref, and reference numeral 229 denotes a switch for short-circuiting both ends of the feedback capacitor Cf. The switch 229 is controlled by a RES_C signal. Reference numerals 217 and 219 are capacitors for holding signal voltages (S signals), and reference numerals 218 and 220 are capacitors for holding noises (N signals). Reference numeral 217 will be referred to as an S signal holding capacitor AB. Reference numeral 219 will be referred to as an S signal holding capacitor A. Reference numerals 218 and 220 will be referred to as an N signal holding capacitors.

Reference numerals 221, 222, 223, and 224 denote write controlling switches into the capacitors. The switch 221 is controlled by a TS_AB signal, and the switch 223 is controlled by a TS_A signal. The switches 222 and 224 are controlled by a TN signal. The reference numerals 225, 226, 227, and 228 denote switches for receiving a signal from the horizontal shift register 232 and outputting a signal to the output amplifier 233. The switches 225 and 226 are controlled by an HAB(m) signal in the horizontal shift register 232, and the switches 227 and 228 are controlled by an HA(m) signal. Herein, “m” means a row number in the read circuit connected to a control signal line. The signals written in the S signal holding capacitor AB 217 and the S signal holding capacitor A 219 are output to the output amplifier 233 via the common output line 230, and the signals written in the N signal holding capacitors 218 and 220 are output to the output amplifier 233 via the common output line 231.

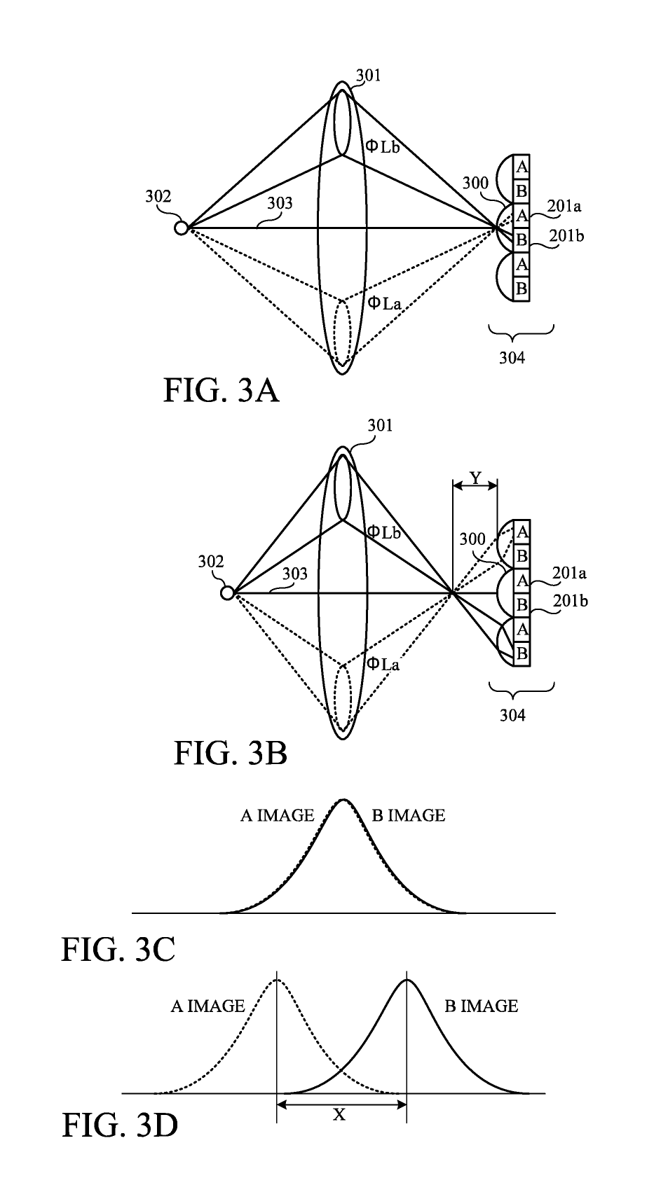

Referring now to FIGS. 3A to 3D, a description will be given of a focus detection operation using the output signal from the image sensor 100. FIGS. 3A and 3B illustrate a relationship between a focus state and a phase difference in the image sensor 100.

In FIGS. 3A and 3B, reference numeral 304 denotes a section in the pixel area 234. Reference numeral 300 denotes a micro lens. One micro lens 300 is provided to each pixel 200 (unit pixel). As described above, the photodiodes 201a and 201b are configured to receive light that has passed the same micro lens. The photodiodes 201a and 201b receive different images having a phase difference, due to the following configuration. In this embodiment, the photodiode 201a is set to a pixel for the A image (A-image pixel), and the photodiode 201b is set to a pixel for the B image (B-image pixel). In FIGS. 3A and 3B, the A-image pixel is illustrated as “A” and the B-image pixel is illustrated as “B.”

This embodiment disposes two photodiodes for one micro lens, but the present invention is not limited to this embodiment. This embodiment is applicable as long as a plurality of photodiodes are disposed for one micro lens in the horizontal or vertical direction.

Reference numeral 301 is an image capturing lens (image capturing optical system) that is assumed as one lens unit that includes the first lens unit 119, the second lens unit 117, and the third lens unit 116. Light emitted from an object 302 passes each area in the image capturing lens 301 around an optical axis 303 as a center, and forms an image on the image sensor 100. In this embodiment, the exit pupil corresponds to the center of the image capturing lens. According to the above configuration, the pupil in the image capturing optical system is symmetrically divided between a view of the image capturing optical system viewed from the A-image pixel and a view of the image capturing optical system viewed from the B-image pixel. In other words, the light from the image capturing optical system is divided into two light fluxes (this division is referred to as a so-called pupil division). The divided light fluxes (first light flux and second light flux) enter the A-image pixel and B-image pixel.

Thus, each of the A-image pixel and the B-image pixel serves as a focus detection pixel as described later, because it receives a light flux from a different pupil area in the exit pupil in the image capturing optical system. The A-image pixel and the B-image pixel also serve as image capturing pixels as described later, because when their image signals are added to each other, an image formed by the light fluxes from the image capturing optical system can be photoelectrically converted and output as an image signal.

A light flux from a specific point on the object 302 is divided into a light flux ΦLa entering the A-image pixel A through the divided pupil corresponding to the A-image pixel A and a light flux ΦLb entering the B-image pixel B through the divided pupil corresponding to the B-image pixel B. Since these two light fluxes are incident from the same point on the object 302, they pass the same micro lens and reach one point on the image sensor, as illustrated in FIG. 3A, in the focus state in the image capturing optical system. Hence, image signals obtained from the A-image pixel A and the B-image pixel B accord with each other.

As illustrated in FIG. 3B, in a defocus state by Y in the optical axis direction, terminal positions of the light fluxes ΦLa and ΦLb shift from each other by a change amount of an incident angle on the micro lens. Therefore, the image signals obtained from the A-image pixel A and the B-image pixel B have a phase difference.

The A-image pixel A and the B-image pixel B (or the focus detection pixels) photoelectrically convert the two object images (A image and B image) having a phase difference, and the photoelectrically converted signals are output to the outside of the image sensor 100 and used for the AF operation, which will be described later. The read operation of the image sensor 100 includes two types due to the following operation: A first read operation for reading only a signal of the A-image pixel A (focus detecting signal), and a second read operation for reading an (image) signal of a sum of a signal of the A-image pixel A and a signal of the B-image pixel B.

Hereinafter, a signal of the A-image pixel A converted into a digital signal through the AFE 102 in the first read operation will be referred to as an A image, and a sum of the signal of the A-image pixel A and the signal of the B-image pixel A converted into a digital signal through the AFE 102 in the second read operation will be referred to as an AB image. A digital signal of the B image for each pixel can be obtained by reading the digital signal of the AB image and the digital signal of the A image for each pixel and by subtracting the A image for each pixel from the A+B image for the same pixel.

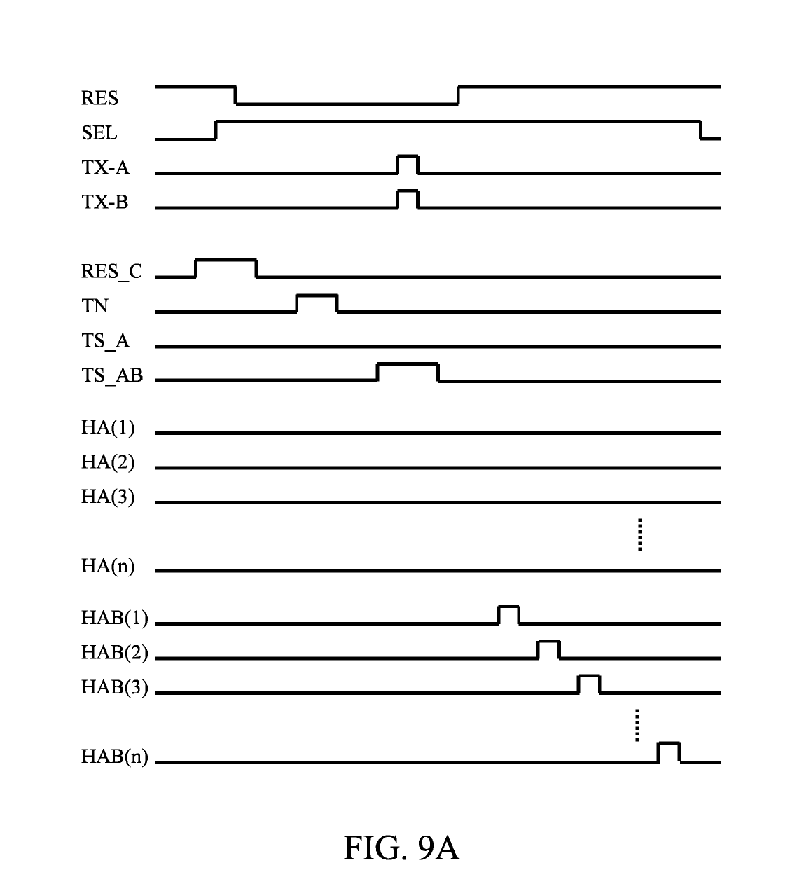

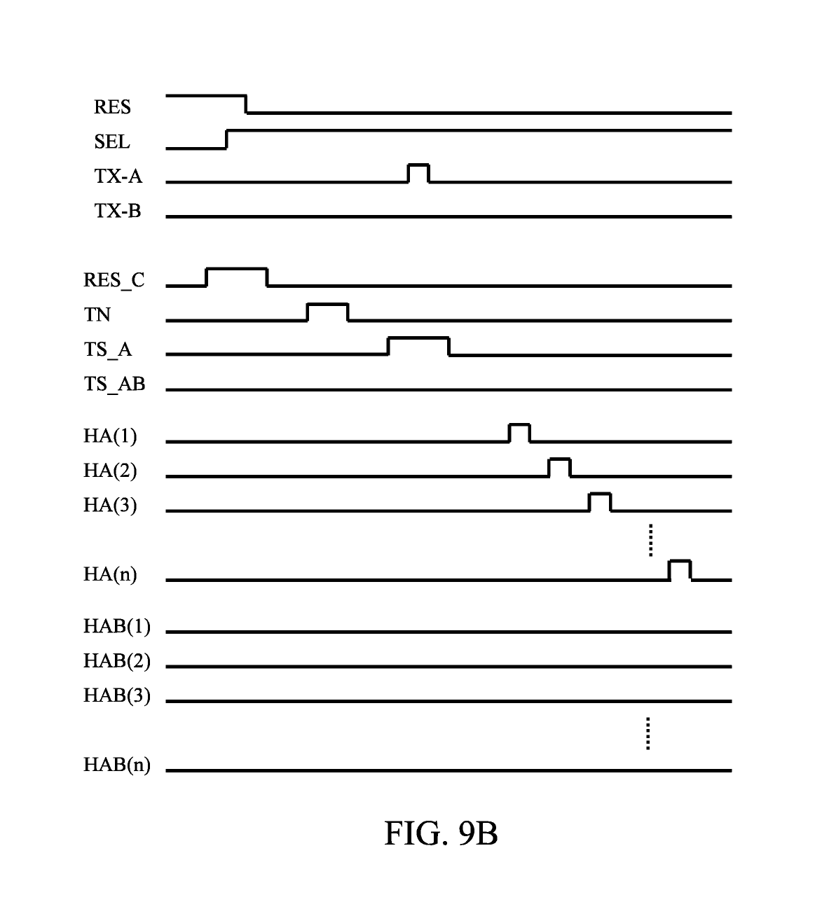

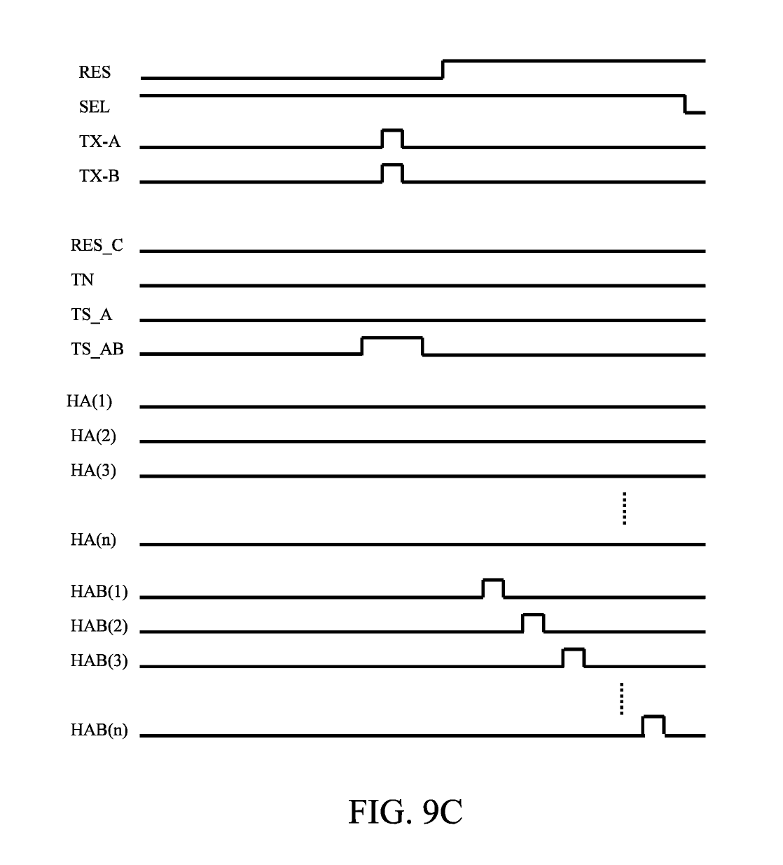

Accordingly, the image sensor 100 performs the second read operation for reading the A+B image in one horizontal scanning period for a usual column. The image sensor 100 performs the first read operation for reading the A image for each pixel in one horizontal scanning period for a designated column, and the second read operation for reading the A+B image for the same column in the next horizontal scanning period. The image sensor 100 obtains outputs of both of the A image and the A+B image by using the two horizontal scanning periods per one designated column for use with the AF operation. This reading method will be described again with reference to FIGS. 2A, 2B, and FIG. 9A as a timing chart. A description will now be given of the second read operation for reading the A+B image in one horizontal scanning period for a usual column.

Initially, the CPU 103 turns a signal RES_C into the H level, turns on the switch 229, and resets the feedback capacitor 214. The CPU 103 turns SEL into the H level, turns on the selection switch 206, and connects the pixel signal for the column to the vertical output line 207. The CPU 103 turns the RES signal into the L level, turns off the reset switch 205 in the FD, and releases the reset state of the FD unit. Thereafter, the CPU 103 turns the RES_C signal into the L level, releases the reset state of the feedback capacitor 214, and clamps the state of the vertical output line 207 in this state in the clamp capacitor 213. The CPU 103 converts a signal TN into the H level, turns on the write switches 222 and 224 for the capacitors, and writes the noise signal N in the N signal holding capacitors 218 and 220.

Next, the signal TN is turned into the L level, and the write switches 222 and 224 are turned off. Next, TS_AB is turned into the H level, the write switch 221 for the capacitor is turned on, the transfer switches TX-A and TX-B are turned into the H levels, and the transfer switches 202a and 202b are turned on. This operation outputs a combined signal of charge signals accumulated in the photodiodes 201a and 201b to the vertical output line 207 via the amplifier 204 and the selection switch 206. The signal of the vertical output signal 207 is amplified in the operational amplifier 215 with a gain determined by a capacitance ratio between the clamp capacitor C0 and the feedback capacitor Cf. The transfer switches 202a and 202b are turned off, then the write switch 221 is turned off, and the combined output of the photodiodes 201a and 201b are written and held in the holding capacitor 217. Thereafter, the RES signal is turned into the H level, and the FD unit is again reset.

Next, the horizontal scanning circuit is scanned, and when HAB(1) is turned into the H level, the pixel output for the first row is output to the output amplifier 233 via the common output line 231. Similarly, as HAB(2) and HAB(3) are sequentially turned into the H levels, an output for one column is output from the output amplifier. Finally, the SEL signal is turned into the L level, and the next line is selected when the SEL signal is next turned into the H level. The A+B image can be obtained on the entire image by repeating the above procedure.

Referring now to FIGS. 9B and 9C, a description will be given of a reading method that includes a first read operation for reading the A image for each pixel in one horizontal scanning period for the next designated column and a second read operation for reading the A+B image in the next horizontal scanning period for the same column. FIG. 9B is a timing chart of an operation for reading the A image in a designated column in one horizontal scanning period. In FIG. 9B, controls over the signals RES_C and TN are the same as those in FIG. 9A.

The signal TN is turned into the L level, the noise signal N is written and stored in the N signal holding capacitors 218 and 220, then the signal TS_A is turned into the H level, and the switch 223 is turned on. The transfer switch 202a is turned on by turning TX-A into the H level. This operation outputs the signal charge accumulated in the photodiode 201a to the vertical output line 207 via the amplifier 204 and the selection switch 206. The signal of the vertical output line 207 is amplified in the operational amplifier 215 with a gain determined by a capacitance ratio between the clamp capacitor C0 and the feedback capacitor Cf. the transfer switch 202a is turned off, the write switch 221 is turned off, and the output of the photodiode 201a is written and stored in the holding capacitor 219. This reading method maintains the RES signal at the L state and does not reset the FD unit at this timing.

Next, the horizontal scanning circuit is scanned, and when the HA(1) is turned into the H level, the pixel output for the first row is output to the output amplifier 233 via the common output line 231. Similarly, HA(2) and HA(3) are sequentially turned into the H levels, and the output for one column is output from the output amplifier. This reading ends the reading of one column without turning the SEL signal into the H level. Thereby, the FD unit holds the electric charges in the photodiode 201a, and maintains the state of the column selected by SEL for reading in the horizontal scanning period illustrated in FIG. 9C.

The signal TS_AB is turned into the H level, the write switch 221 is turned on, TX-A and TX-B are turned into the H levels, and the transfer switches 202a and 202b are turned on. Thereby, the output of the photodiode 201b and the signal of the photodiode 201a held in the FD unit are added to each other (summed up). The added charge signal is output to the vertical output line 207 via the amplifier 204 and the selection switch 206. The signal of the vertical output line 207 is amplified in the operational amplifier 215 with a gain determined by a capacitance ratio between the clamp capacitor C0 and the feedback capacitor Cf. Thereafter, the RES signal is turned into H, and the FD unit is again reset.

Next, the horizontal scanning circuit is scanned, and when the HAB(1) is turned into the H level, the pixel output of the first row is output to the output amplifier 233 via the common output line 231. Similarly, HAB(2) and HAB(3) are sequentially turned into the H levels, and the output for one column is output from the output amplifier. The SEL signal is finally turned into the L level, and the next row is selected when the SEL signal next turns into the H level. This operation requires two horizontal scanning periods for the designated column, and can sequentially read the A image signal and the A+B image signal on the same column.

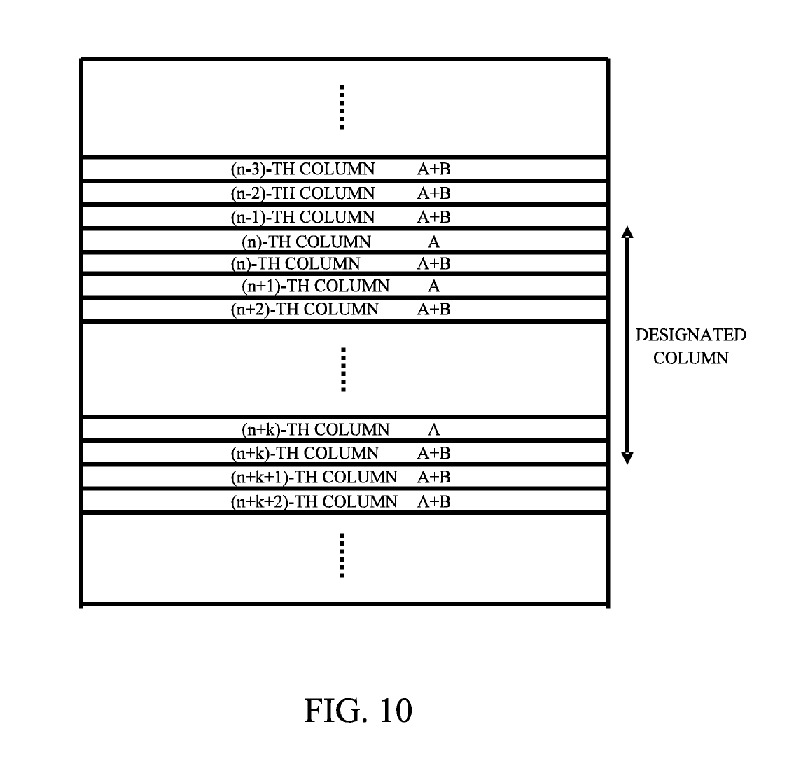

FIG. 10 is an explanatory view of thus read image data. The example in FIG. 10 illustrates reading of the A image and the A+B image so as to use k+1 columns from n-th column to (n+k)-th column in an image for the focus detection operation. An image cant be generated by selecting and using only the A+B image in each column, similar to usual reading.

The A image and the A+B image are obtained in the k+1 columns from the n-th column to the (n+k)-th column. Since the B image for each pixel can be obtained by subtracting the output of the A image from the output of the A+B image for each pixel, the A image and the B image are consequently obtained in each line and a focal length can be calculated based on this result.

Next follows a description of a focus detection operation performed in the AF calculator 110 with the A image and the B image obtained by the image sensor 100. FIG. 3C corresponds to FIG. 3A, and illustrates the A image and the B image in a focus state (in-focus state). In FIG. 3C, an abscissa axis represents a pixel position, and an ordinate axis represents an output. In the focus state, the A image accords with the B image. FIG. 3D corresponds to FIG. 3B, and illustrates the A image and the B image in a defocus state. At this time, the A image and the B image have a phase difference in the above state, and pixel positions shift by a shift amount X.

The AF calculator 110 calculates a defocus amount or the Y value in FIG. 3B by calculating a shift amount X based on the input A and B images. The AF calculator 110 calculates a drive amount of the third lens unit 116 based on the calculated Y value, and transfers it to the focus drive circuit 112. The focus drive circuit 112 outputs a drive command to the focus actuator 114 based on the lens drive amount obtained from the AF calculator 110. The third lens unit 116 is driven to a focus position by the focus actuator 114 so as to set a focus state (in-focus state) on the image sensor 110.

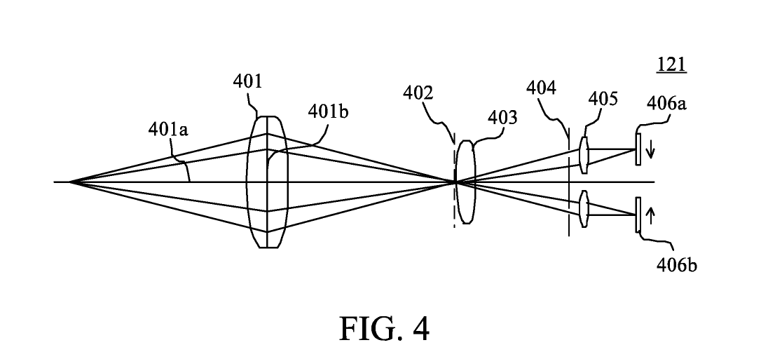

Referring now to FIG. 4, a description will be given of a focus detection operation in the AF calculator 110 using the pixel signal output from the AF sensor 121. FIG. 4 is a schematic view of the AF sensor 121. FIG. 4 illustrates developed components on an optical axis 401a in an image capturing lens 401, although FIG. 4 omits the main mirror 123 and the sub mirror 120.

The AF sensor 121 includes a field lens 403, a diaphragm 404 having a pair of apertures, a pair of secondary imaging lenses 405, and AF pixels 406a and 406b including a pair of photoelectric conversion element rows, etc.

A light flux emitted from one point on the optical axis 401a passes the image capturing lens 401, then forms an image on the image sensor 402, and forms images with a predetermined interval on the pair of AF pixels 406a and 406b via the field lens 403, the diaphragm 404, and the secondary imaging lens 405. The field lens 403 is disposed so that the pupil 401b in the image capturing lens 401 and entrance pupils in the pair of secondary imaging lens 405 or the vicinities of the diaphragm 404 can be imaged. The pupil 401b in the image capturing lens 401 corresponds to a pair of apertures in the diaphragm 404, and is longitudinally divided in FIG. 4.

According to this configuration, for example, when the image capturing lens 401 is moved to the left in FIG. 4 and the light flux is imaged on the left side of the image sensor 402, a pair of images move in arrow directions on the pair of AF pixels 406a and 406b. The AF calculator 110 calculates a relative shift amount between the pair of images based on the pixel signals from the AF pixels 406a and 406b for a focus detection and focus driving of the image capturing lens 401. When the image capturing lens 401 is moved to the right in FIG. 4, the pair of images on the pair of AF pixels 406a and 406b move in a direction opposite to the arrow directions in FIG. 4. As described above, the AF sensor 121 includes a plurality of pairs of AF pixel rows, and each of the pair of AF pixel rows corresponds to one focus detection point and the AF pixel rows are discretely arranged.

As described above, in the image capturing apparatus 10 according to this embodiment, the AF calculator 110 provides a focus detection of the image capturing lens 401 and makes the image capturing lens accurately focus on the object based on any one of the image sensor 100 and the AF sensor 121.

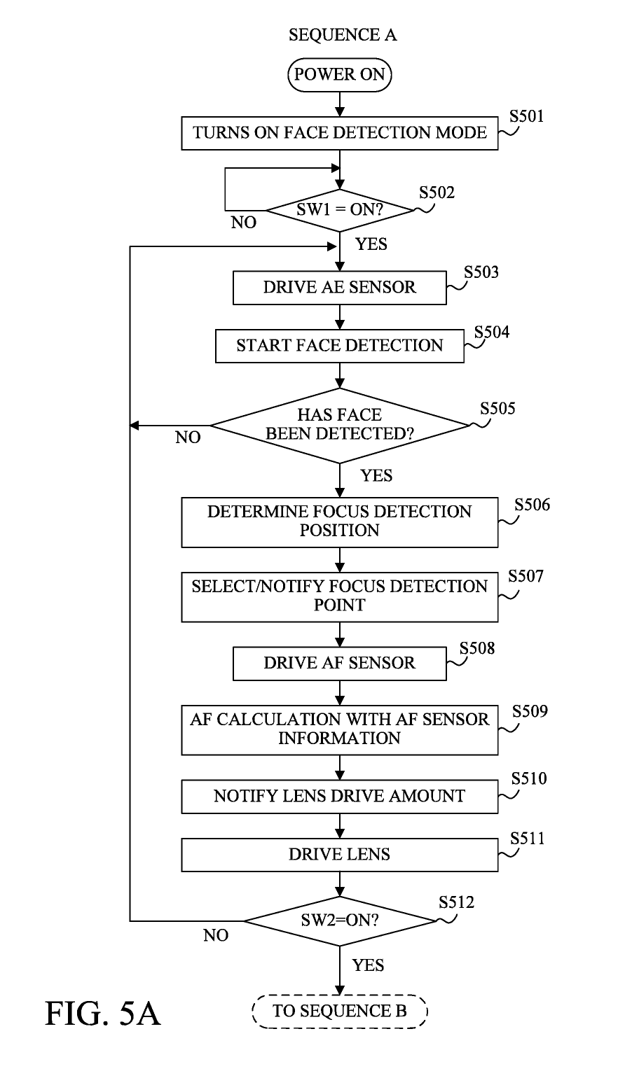

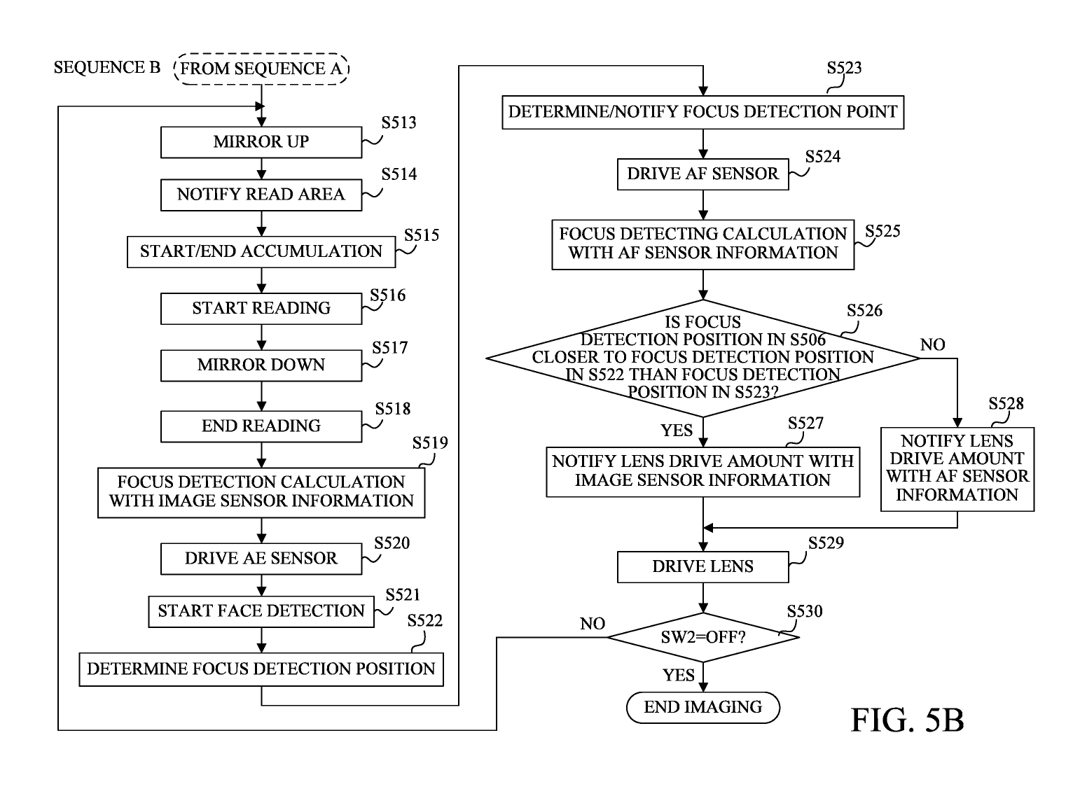

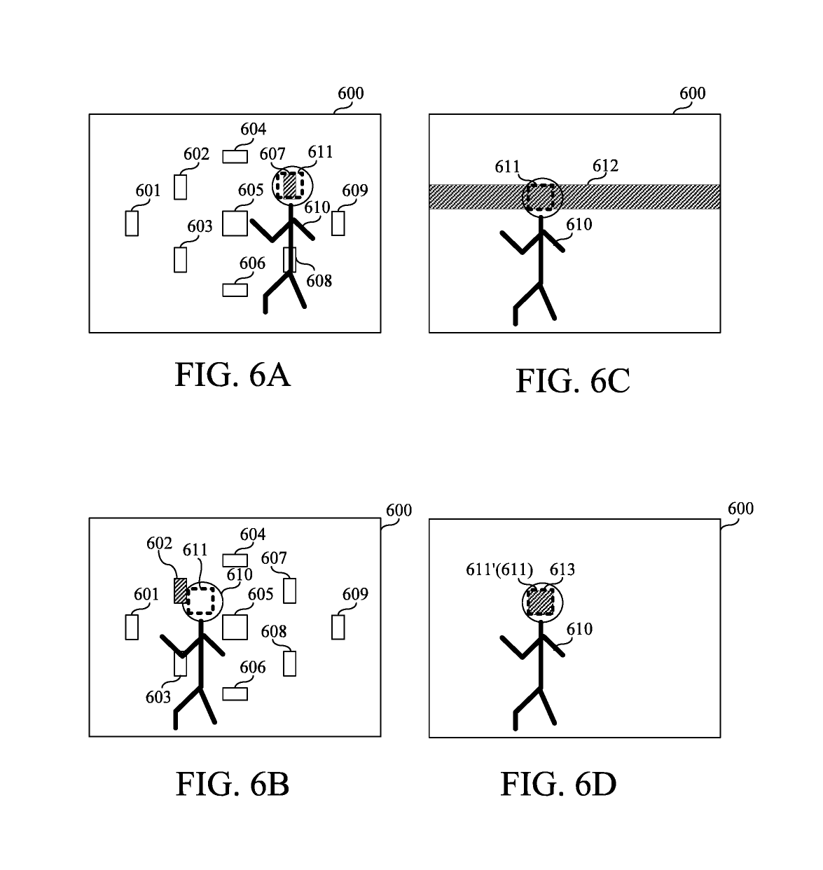

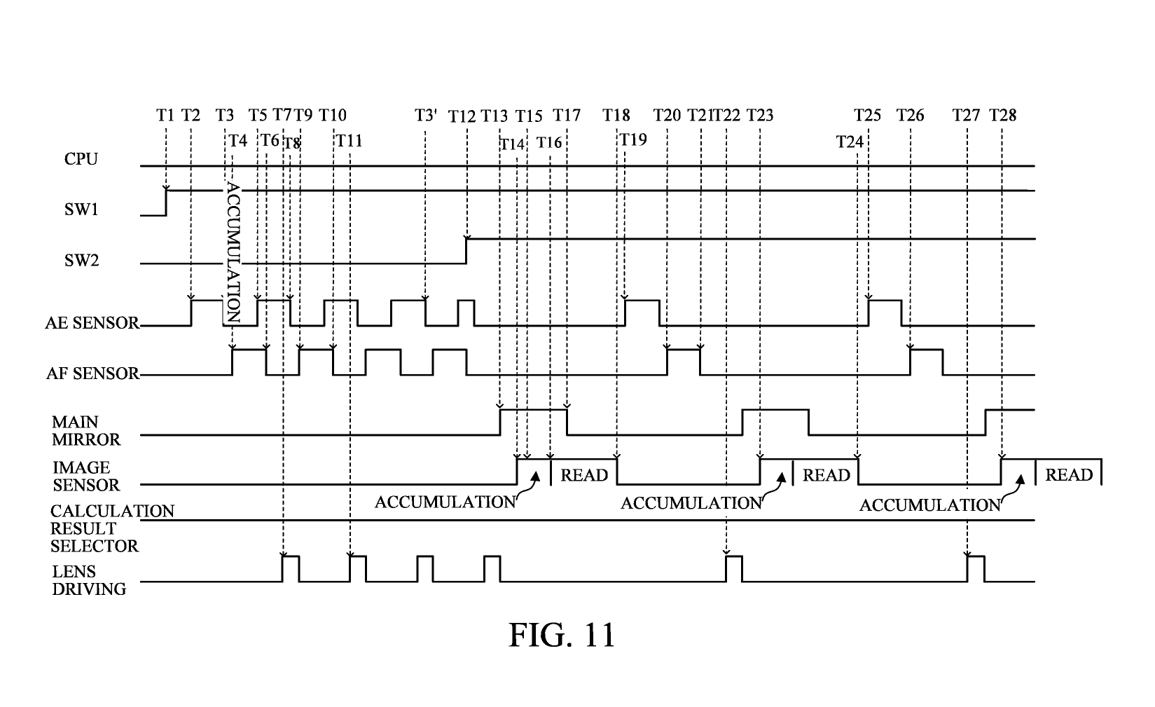

Next follows a description of the image capturing apparatus 10 according to this embodiment with reference to FIGS. 5A, 5B, 6A to 6D, and 11. FIGS. 5A and 5B are flowcharts of the focus detection in the image capturing apparatus 10 according to this embodiment. Each step in FIGS. 5A and 5B is executed by each component mainly based on a command of the CPU 103 in the image capturing apparatus 10. FIGS. 6A to 6D are illustrative images in the focus detection. FIG. 11 is a timing chart of the focus detection.

When a power switch in the operation unit 104 is pressed, the image capturing apparatus 10 is powered on and turned into the image capturing mode. In the step S501 in FIG. 5A, the user presses the mode switch in the operation unit 104 and selects a face detecting mode. Then, the CPU 103 sets the face detecting mode for detecting a face in the main object using the AE sensor 130.

Next, in the step S502, the CPU 103 continues to detect whether SW1 is pressed until SW1 is pressed. When detecting the press of SW1 at time T1 in the timing chart in FIG. 11, the CPU 103 drives the AE sensor 130 at time T2 in the step S503, and obtains an image from the AE sensor 130 by time T3. The image obtained from the AE sensor 130 is an image 600 in FIGS. 6A to 6D, for example.

Next, in the step S504, the CPU 103 starts a face detecting operation for detecting whether a face is included in the image obtained in the step S503. Next, in the step S505, the CPU 103 moves to the step S503 where the face is not detected. Until the face is detected, the CPU 103 repeats the steps S503 to S505.

Where the face is detected in the step S505, for example, in FIGS. 6A to 6D, of a person 610 as a main object, the CPU 103 moves to the step S506. In the step S506, the CPU 103 determines a focus detection position based on a position coordinate of a face detected in the step S505. In FIGS. 6A to 6D, the CPU 103 determines a frame illustrated by a dotted line as a focus detection position 611 for a focus detection in the position coordinate of the face of the detected person 610. Information of the focus detection position 611 is necessary information in the step S526, which will be described later. Thus, the CPU 103 stores the information of the focus detection position 611 in the RAM 107.

Next, in the step S507, the CPU 103 selects a pixel or a focus detection point read from the AF sensor 121 based on the result of the step S506. The CPU 103 determines a pixel area in a first read operation for a focus detection from the image sensor 100.

A description will now be given of selecting a focus detection point on the AF sensor 121. In FIGS. 6A and 6B, focus detection points 601 to 609 on the AF sensor 121 are displayed at corresponding positions on the image 600 obtained from the AE sensor 130. In the illustrative image in FIG. 6A, the focus detection point 607 (hatched focus detection point) overlaps the focus detection position 611 in the frame illustrated by the dotted line. Thus, the CPU 103 selects the focus detection point 607 among the focus detection points 601 to 609 on the AF sensor 121.

On the other hand, where the focus detection position does not overlap any one of the focus detection points on the AF sensor 121, the CPU 103 selects the focus detection point closest to the focus detection position 611. For example, in the illustrative image in FIG. 6B, the focus detection position 611 does not overlap any one of the focus detection points 601 to 609. In this case, the CPU 103 selects the focus detection point 602 closest to the focus detection point 611 among the focus detection points 601 to 609 as the focus detection point on the AF sensor 121. The CPU 103 notifies the AF sensor controller 126 of information of the selected focus detection point.

Next follows a description of determining a pixel area in a first read operation for a focus detection from the image sensor 100. In FIG. 6C, a pixel area 612 in the first read operation for a focus detection from the image sensor 100 is displayed at a corresponding position on the image 600 obtained from the AE sensor 130. The image 600 obtained from the AE sensor 130 in FIG. 6C is the same image as that in FIG. 6B. The CPU 103 determines the pixel area 612 as an area in the first read operation for a focus detection from the image sensor 100 so that the area coincides with the focus detection position 611 in the column direction in the illustrative image in FIG. 6C. Thus, the CPU 103 executes the step S508 at time T4, and operates the AF sensor 121 using the AF sensor controller 126. The AF sensor 121 reads the focus detection point selected by the CPU 103 in the step S507.

Next, in the step S509, the CPU 103 (AF calculator 110) calculates a drive amount to be notified to the focus drive circuit 112 using the pixel signal read from the AF sensor 121 by time T6 in the step S508. Next, in the step S510, the CPU 103 notifies the drive amount calculated in the step S509 to the focus drive circuit 112, at time T7. Next, in the step S511, the CPU 103 operates the focus drive circuit 112 based on the drive amount notified in the step S510, drives the focus actuator 114, and moves the third lens unit 116 (lens driving).

Next, in the step S512, the CPU 103 repeats the operations of the steps S503 to S512 at times T5, T8, T9, T11, etc. until pressing of the SW2 is detected. In other words, while only SW1 is being pressed, the focus detection using the image sensor 100 is not performed and the focus detection and lens driving operation are performed only with the AF sensor 121.

In the timing chart illustrated in FIG. 11, the CPU 103 stores in the RAM 107 the focus detection position determined based on the read result of the AE sensor 130 by T3′ just before SW2 is pressed. When SW2 is pressed at time T12, the flow moves to the step S513 in FIG. 5B.

In the step S513, the CPU 103 drives the main mirror 123 and the sub mirror 120 at time T13 using the mirror driver 122, and moves up the mirrors. After the mirrors are moved up, an optical image introduced to the penta-prism 124, the AE sensor 130, and the AF sensor 121 are guided to the image sensor 100. Since the shutter just in front of the image sensor 100 closes at this time, the image sensor 100 is not exposed.

Next, in the step S514, the CPU 103 prepares for a control over the TG 101 at time T14 in the first read operation from the image sensor 100 for the focus detection with the pixel area 612 determined in the step S507 just before pressing of SW2 is detected. The CPU 103 prepares for a control over the TG 101 in a second read operation for all pixels from the image sensor 100 so as to obtain an image.

Next, in the step S515, the CPU 103 starts accumulating electric charges in the image sensor 100 by moving a front curtain in the focal plane shutter 111 at time T15. The CPU 103 finishes accumulating the electric charges by moving a rear curtain in the focal plane shutter 111 after a predetermined accumulation time period passes, and moves to the step S516. In the step S516, the CPU 103 starts a read operation from the image sensor 100 at time T16. The first read operation reads a pixel area 612 for which the TG 101 is controlled in the step S514, and the second read operation reads all pixels.

Next, in the step S517, the CPU 103 drives or moves down the main mirror 123 and the sub mirror 120 at time T17 using the mirror driver 122. After the mirrors are moved down, the optical images are introduced to the pentaprism 124, the AE sensor 130, and the AF sensor 121. In the step S518, the CPU 103 moves to the next step S519 after the read operation from the image sensor 100 is completed by time T18.

In the step S519, the CPU 103 calculates a drive amount to be notified to the focus drive circuit 112 using the AF calculator 110 with the A image and the B image calculated by subtracting the A image from the A+B image obtained from the image sensor 100 in the step S518. Referring to FIGS. 6C and 6D, a description will be given of the pixel area used to calculate the drive amount in the step S519. FIG. 6D illustrates a pixel area 613 at a corresponding position on the image 600 obtained from the AE sensor 130, where the pixel area 613 is used to calculate the drive amount in the pixel area 612 in the first read operation for the focus detection from the image sensor 100. In the illustrative image illustrated in FIGS. 6C and 6D, the CPU 103 controls the AF calculator 110 so as to calculate the drive amount by obtaining object distance information of the pixel area 613 that coincides with the focus detection position 611 in position coordinate in the pixel area 612 read in the first read operation.

Next, in the step S520, the CPU 103 drives the AE sensor 130 at time T19, and obtains an image from the AE sensor 130. Next, in the step S521, the CPU 103 detects a face contained in the image obtained in the step S520. Next, in the step S522, the CPU 103 determines the focus detection position based on the position coordinate of the face detected in the step S521. The determined focus detection position is information that is likely necessary in the following steps. Thus, the CPU 103 stores the focus detection position in the RAM 107.

Next, in the step S523, the CPU 103 selects a pixel to be read from the AF sensor 121 or a focus detection point based on the result in the step S522. Where the focus detection position does not overlap any one of focus detection points on the AF sensor 121, the CPU 103 selects the focus detection point closest to the focus detection position similar to the step S507. The CPU 103 notifies the AF sensor controller 126 of information of the selected focus detection point. The CPU 103 determines the pixel area to be read in the first read operation for a focus detection from the image sensor 100. The operation of the CPU 103 in the step S523 is similar to that in the step S507.

Next, in the step S524, the CPU 103 operates the AF sensor 121 using the AF sensor controller 126 at time T20. The AF sensor 121 operates so as to read the pixel at the focus detection point selected by the CPU 103 in the step S523. Next, in the step S525, the CPU 103 (AF calculator 110) calculates a drive amount notified to the focus drive circuit 112 by time T21 using the pixel signal read from the AF sensor 121 in the step S524.

Next, in the step S526, the CPU 103 compares the pixel area 613 based on the focus detection position 611 determined in the step S506, the focus detection point determined in the step S523, and a focus detection position 611′ determined in the step S522 with one another. The pixel area 613 is an area used for a focus detection in the pixel area 612 for the first read operation from the image sensor 100, which has been determined based on the focus detection position 611 in the step S506 just before SW2 is pressed. More specifically, in the step S526, the CPU 103 (calculator 103b) determines whether the pixel area 613 (focus detecting area or the first area) on the image sensor 100 is closer to the focus detection position 611′ (object area) than the focus detection point (second area) on the AF sensor 121. Assume that in the illustrative image in FIG. 6D, the focus detection position 611′ determined in the step S522 does not change from the just previously determined focus detection position 611. Then, the pixel area 613 used to calculate the drive amount and determined in the step S519 is closer to the focus detection position 611′ (=611) determined in the step S522.

In this case or where the first area (pixel area 613 or focus detection area) on the image sensor 100 is closer to the object area (focus detection position 611′) than the second area (focus detection point) on the AF sensor 121, the flow moves to the step S527. In the step S527, the CPU 103 (calculator 103b) calculates a defocus amount using first pair signals obtained from the image sensor 100. Where the first area on the image sensor 100 is farther than the object area than the second area on the AF sensor 121, the flow moves to the step S528. In the step S528, the CPU 103 (calculator 103b) calculates a defocus amount using second pair signals obtained from the AF sensor 121.

In the step S527, the CPU 103 notifies the focus drive circuit 112 of the drive amount calculated in the step S519. On the other hand, in the step S528, the CPU 103 notifies the focus drive circuit 112 of the drive amount calculated in the step S525.

Next, in the step S529, the CPU 103 drives the third lens unit 116 using the focus drive circuit 112 and the focus actuator 114 based on the drive amount notified in the step S527 or S528 at time T22. Next, in the step S530, the CPU 103 detects whether SW2 is being pressed. When SW2 is being pressed, the flow moves to the step S513 so as to repeat the operation from the step S513 to S529. In this case, for example, in order to capture a still image from time T28 three frames after SW2 is pressed, the lens driving information just before time T27 is reset by comparing the calculation result of the lens drive amount by the image sensor 100 with the calculation result of the lens drive amount by the AF sensor 121. The calculation result of the lens drive amount by the image sensor 100 is the calculation result of the lens drive amount from the image sensor 100 simultaneous with still image capturing of the second frame that ends by just previous time T24 (or based on the face detection result at just previous time T19). The calculation result of the lens drive amount by the AF sensor 121 is the calculation result of the lens drive amount from the AF sensor 121 at time T26 (based on the face detection result from just previous time T25). When it is detected that SW2 is not pressed in this repetitive operation, the image capturing operation ends.

Although not explicitly described in the flowchart in this embodiment, it is unnecessary for all the steps S501 to S530 to wait for the previous steps. For example, before the CPU 103 notifies the focus drive circuit 112 of the drive amount in the step S519, driving of the AE sensor 130 in the step S520 may start. In other words, the parallel operation is available. This configuration enables a focus detection using the image sensor 100 even at a position where the focus detection is not available with the AF sensor 121.

This embodiment controls reading from the image sensor 100 with the TG 101 by determining for each column whether the A image is to be read, but the present invention is not limited to this embodiment. The read control may use a row unit or part of a column or row unit. In the control with a row unit, the CPU 103 determines the area in the first read operation from the image sensor 100 so that the pixel area 612 in the step S507 coincides with the focus detection position 611 in the row direction.

In this embodiment, the CPU 103 (focus detection point selector) reads a corresponding pixel at the position of the selected focus detection point from the AF sensor 121, but the present invention is not limited to this embodiment. This embodiment can read an area outside of the focus detection point as the necessary area for the calculation. A plurality of pixels may be read corresponding to the plurality of focus detection points near the focus detection point selected by the CPU 103, or the selected focus detection point may be preferentially read and other focus detection points may be read later.

### Second Embodiment

Next follows a description of a second embodiment of the present invention. The first embodiment determines the focus detection position using the image sensor 100 based on the AE operation result in the last frame. Where the object moves significantly, the previously determined focus detection position of the image sensor 100 is significantly different from the focus detection position determined based on the AE operation result just before the still image capturing, and consequently may be always unselected. Accordingly, this embodiment sets the area in the first read operation using the image sensor 100 wider than that in the first embodiment. Thereby, even when the object moves significantly, an effective focus detection can be provided with the image sensor 100.

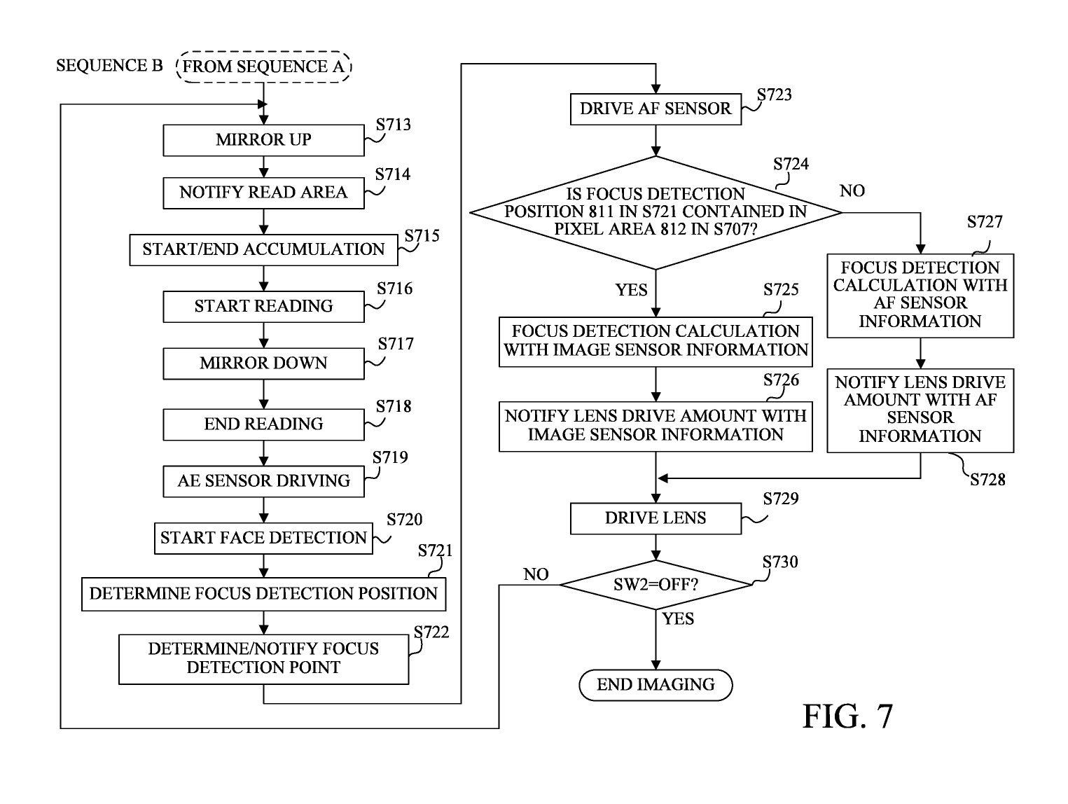

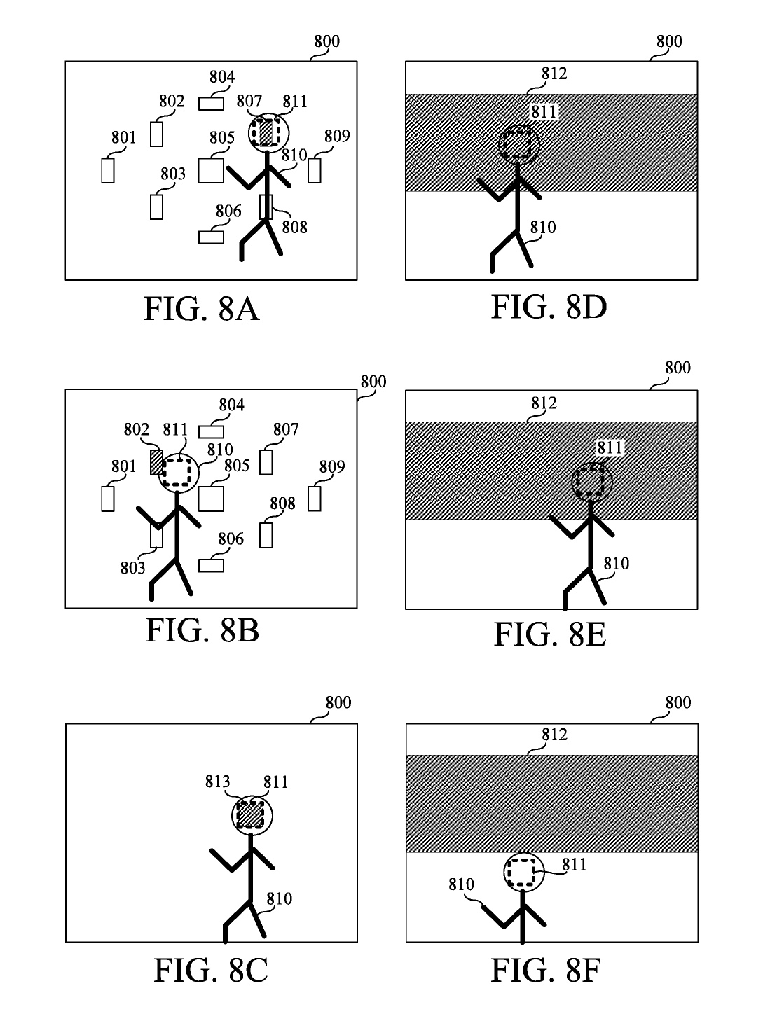

Referring to FIGS. 7 and 8A to 8F, a description will be given of an operation of the image capturing apparatus 10 according to this embodiment. FIG. 7 is a flowchart (sequence B) in the focus detection in the image capturing apparatus 10 according to this embodiment, and the sequence A is similar to that illustrated in FIG. 5A according to the first embodiment. In other words, the steps S713 to S730 in FIG. 7 follow the step S501 to S512 in FIG. 5A. In addition, the steps S713 to S718 in FIG. 7 is similar to the steps S513 to S518 in FIG. 5B. Hence, a common description to the first embodiment with respect to FIGS. 5A and 7 will be omitted. Each step in FIG. 7 is executed by each component mainly based on a command of the CPU 103 in the image capturing apparatus 10. FIGS. 8A to 8F illustrate illustrative images in the focus detection. In FIGS. 8A to 8F, reference numeral 800 denotes image information which the CPU 103 obtains from the AE sensor 130. Reference numerals 801 to 809 are positions corresponding to the focus detection points on the AF sensor 121. Reference numeral 810 denotes an object (person). Reference numeral 811 denotes a focus detection position determined by the CPU 103. Reference numeral 812 denotes a pixel area in the first read operation for a focus detection from the image sensor 100. Reference numeral 813 in FIG. 8C denotes a pixel area used for a calculation in the AF calculator 110 for the focus detection from the pixel area 812 in the first read operation from the image sensor 100. The pixel area 813 is a pixel area that coincides with the focus detection position 811 in position coordinate.

In the step S502, the CPU 103 continues to determine whether SW1 is pressed until SW1 is pressed. When detecting that SW1 is pressed, the CPU 103 drives the AE sensor 130 and obtains an image from the AE sensor 130 in the step S503. The image obtained from the AE sensor 130 corresponds to the image 800 in FIGS. 8A to 8F.

When the CPU 103 does not detect a face in the step S505, the CPU 103 moves to the step S503 so as to repeat the step S503 to S505 until the CPU detects a face. Where the CPU 103 detects the face in the step S505, for example, for the person 810 as a main object in FIGS. 8A to 8F, the flow moves to the step S506. In the step S506, the CPU 103 determines the focus detection position based on the position coordinate of the face detected in the step S505. In FIGS. 8A to 8F, the CPU 103 determines the frame 811 illustrated by a dotted line as the focus detection position for a focus detection at the face position coordinate of the detected person 810.

In the step S507, the CPU 103 selects a pixel to be read from the AF sensor 121 or a focus detection point based on the result of the step S706. The CPU 103 determines the pixel area in the first read operation for the focus detection from the image sensor 100. A description will now be given of a selection method of the focus detection point on the AF sensor 121. In FIGS. 8A and 8B, the focus detection points 801 to 809 on the AF sensor 121 are illustrated at corresponding positions on the image 800 obtained from the AE sensor 130. In the illustrative image in FIG. 8A, the focus detection point 807 (hatched focus detection point) overlaps the focus detection position 811 in the frame illustrated by a dotted line. Hence, the CPU 103 selects the focus detection point 807 among the focus detection points 801 to 809 on the AF sensor 121. Where the focus detection position does not overlap any one of the focus detection points on the AF sensor 121, the CPU 103 selects the focus detection point closest to the focus detection position. For example, in the illustrative image in FIG. 8B, the focus detection position 811 does not overlap any one of the focus detection points 801 to 809. In this case, the CPU 103 selects the focus detection point 802 closest to the focus detection position 811 among the focus detection points 801 to 809 on the AF sensor 121.

The CPU 103 determines a pixel area in the first read operation for the focus detection from the image sensor 100. This determination will be described with reference to FIG. 8D. FIG. 8D illustrates the pixel area 812 in the first read operation for the focus detection from the image sensor 100, at the corresponding position on the image 800 obtained from the AE sensor 130. In the illustrative image in FIG. 8D, the CPU 103 determines the pixel area 812 as an area in the first read operation for the focus detection from the image sensor 100 so as to read extra columns before and after the focus detection position 811 in the column direction.

In the step S716 in FIG. 7, the CPU 103 starts the read operation from the image sensor 100. The first read operation reads the pixel area 812 used to control the TG 101 in the step S714 and all pixels are read in the second read operation.

In the step S718, the CPU 103 moves to the next S719 when the read operation from the image sensor 100 ends. In the step S719, the CPU 103 drives the AE sensor 130 and obtains the image from the AE sensor 130. Next, in the step S720, the CPU 103 detects a face in the image obtained in the step S719. Next, in the step S721, the CPU 103 determines the focus detection position based on the face position coordinate detected in the step S720. The detected focus detection position is information necessary for the following steps. The CPU 103 stores the focus detection position in the RAM 107.

Next, in the step S722, the CPU 103 selects a pixel to be read from the AF sensor 121 or a focus detection point based on the result of the step S721. Where the focus detection position does not overlap any one of the focus detection points on the AF sensor 121, the CPU 103 selects the focus detection point closest to the focus detection position, similar to the step S507. The CPU 103 notifies the AF sensor controller 126 of the information of the selected focus detection point. The CPU 103 determines the pixel area to be read in the first read operation for the focus detection from the image sensor 100. The operation of the CPU 103 in the step S722 is similar to that in the step S507. Next, in the step S723, the CPU 103 operates the AF sensor 121 using the AF sensor controller 126. The AF sensor 121 operates so as to read the pixel of the focus detection point selected by the CPU 103 in the step S722.

Next, in the step S724, the CPU 103 compares the focus detection position 811 determined in the step S721 with the pixel area 812 determined in the step S507. More specifically, the CPU 103 (calculator 103b) determines whether the object area (focus detection position 811 in FIGS. 8E and 8F) is contained in the pixel area (pixel area 812 in FIGS. 8E and 8F) that contains the first area on the image sensor 100. In FIGS. 8E and 8F, the pixel area 812 in the first read operation for the focus detection form the image sensor 100 in the step S507 is illustrated at the corresponding position on the image 800 obtained from the AE sensor 130 in the step S719. Where the focus detection position 811 is contained in the pixel area 812 as in the illustrative image in FIG. 8E, the flow moves to the step S725. On the other hand, where a moving amount of the object or an image capturing direction of a photographer significantly changes and the focus detection position 811 is not contained in the pixel area 812 as in the illustrative image in FIG. 8F, the flow moves to the step S727.

In the step S725, the CPU 103 (AF calculator 110) calculates a drive amount to be notified to the focus drive circuit 112 using the A image and the B image obtained by subtracting the A image from the A+B image obtained from the image sensor 100 in the step S718. The pixel area 813 used for a calculation by the CPU 103 is an area that coincides with the focus detection position 811 in position coordinate in the pixel area 812.

Referring now to FIGS. 8C and 8E, a description will be given of a pixel area used to calculate the drive amount in the step S725. FIG. 8C illustrates a pixel area 813 used to calculate the drive amount in the pixel area 812 in FIG. 8E in the first read operation for the focus detection from the image sensor 100, at a corresponding position on the image 800 obtained from the AE sensor 130. In FIGS. 8C and 8E, the CPU 103 controls the AF calculator 110 so as to calculate the drive amount using the A image and the B image in the pixel area 813 which coincides with the focus detection position 811 in position coordinate determined in the step S522, in the pixel area 812 read in the first read operation.

In the step S726, the CPU 103 notifies the focus drive circuit 112 of the drive amount calculated in the step S725. In the step S727, the CPU 103 (AF calculator 110) calculates the drive amount notified to the focus drive circuit 112 using the pixel signal read from the AF sensor 121 in the step S723. Next, in the step S728, the CPU 103 notifies the focus drive circuit 112 of the drive amount calculated in the step S727.

Next, in the step S729, the CPU 103 operates the focus drive circuit 112 based on the drive amount calculated in the step S726 or S728, drives the focus actuator 114, and moves the third lens unit 116. Next, in the step S730, the CPU 103 detects whether SW2 is being pressed. Where SW2 is being pressed, the flow moves to the step S713 so as to repeat the steps S713 to S729. Where SW2 is not being pressed, the CPU 103 ends the image capturing operation.

Although not explicitly described in the flowchart in this embodiment, it is unnecessary for all steps to wait for the previous steps. For example, before the CPU 103 notifies the focus drive circuit 112 of the drive amount in the step S719, driving of the AE sensor 130 in the step S720 may start. In other words, the parallel operation is available. This configuration enables a focus detection using the image sensor 100 even at a position where the focus detection is not available with the AF sensor 121.

In the steps S507 and S721, the pixel area 812 is wider than the focus detection position 811 so as to contain the predetermined extra columns but this number of columns may be set in a readable range in the system configuration. For example, a system configuration that can maintain a frame rate of the consecutive captures may set all pixels for the pixel area 812. This embodiment controls reading from the image sensor 100 with the TG 101 by determining for each column whether the A image is to be read, but the present invention is not limited to this embodiment. The read control may use a row unit or part of a column or row unit.

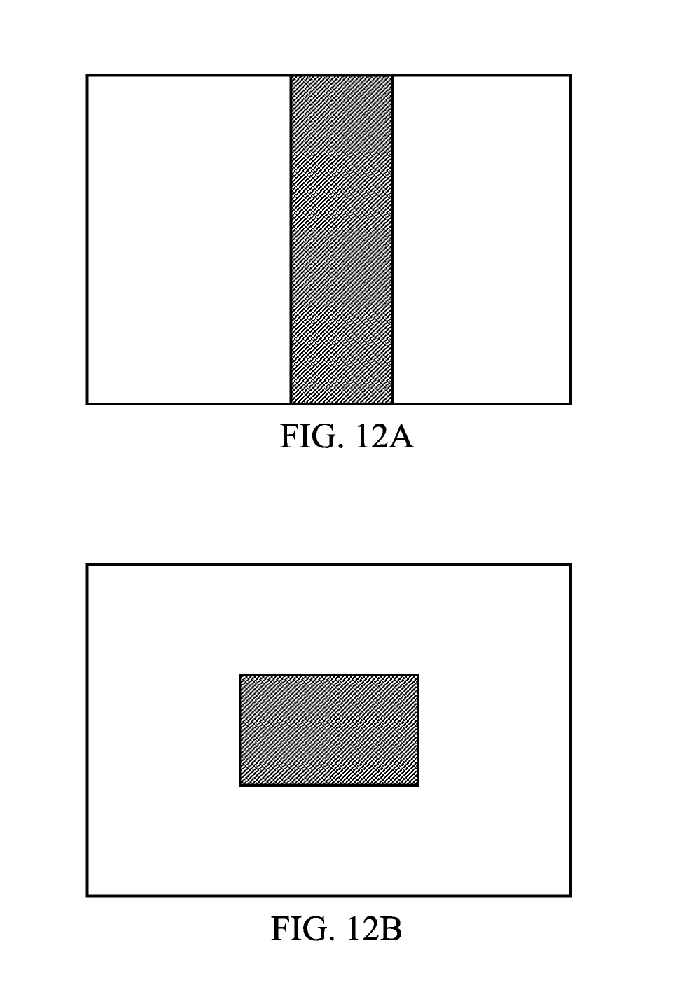

An illustrative reading method will be described with reference to FIGS. 12A and 12B. FIG. 12A is an explanatory view where the read area for the A image is set to limited rows. This operation can be realized by reading all columns with the reading method in FIGS. 9B and 9C, and by outputting only pulses corresponding to the designated rows in which the pulse HA(n) is designated for the horizontal transfer operation in FIG. 9B. FIG. 12B is an explanatory view where the A image is read only in an area with limited columns and the rows. This operation can be realized by reading only the selected area with the reading method in FIGS. 9B and 9C, and by outputting only pulses corresponding to the designated rows in which the pulse HA(n) is designated for the horizontal transfer operation in FIG. 9B. Under the control in a row unit, in the steps S507 and S721, the CPU 103 may determine the pixel area 812 so as to read the extra columns before and after the focus detection position 811 in the row direction.

While this embodiment reads corresponding pixels at the position of the focus detection point on the AF sensor 121 selected by the CPU 103 (focus detection point selector), the present invention is not limited to this embodiment. This embodiment can read a plurality of pixels corresponding to a plurality of focus detection points near the focus detection point selected by the CPU 103 or the selected focus detection position may be preferentially read and other focus detection points may be read later.

According to each embodiment, the control apparatus (CPU 103) includes the signal acquirer 103a and the calculator 103b. The signal acquirer 103a acquires first pair signals for a focus detection from a first area (focus detecting area) on the image sensor 100, and second pair signals for a focus detection from the second area (focus detection point) on the AF sensor 121. The calculator 103b calculates a defocus amount using the first pair signals or the second pair signals based on the first area on the image sensor 100 and the second area on the AF sensor 121.

The control apparatus may include an area acquirer 103c configured to acquire an object area (such as a face area) detected by an object detector (AF sensor 130). The calculator 103b may calculate the defocus amount using the first pair signals or the second pair signals based on the object area, the first area on the image sensor 100, and the second area on the AF sensor 121.

The first area on the image sensor 100 may be part of a predetermined pixel area on the image sensor 100 determined based on the object area. The second area on the AF sensor 121 may be one focus detection point selected from a plurality of focus detection points on the AF sensor 121 determined based on the object area.

The image sensor 100 may control a first read operation configured to read part of a plurality of two-dimensionally arranged first photoelectric converters and a plurality of two-dimensionally arranged second photoelectric converters for a focus detection, and a second read operation configured to read all of the plurality of first photoelectric converters and the plurality of second photoelectric converters so as to obtain an image. The image sensor may control the first read operation for each column or row (in a column unit or in a row unit).

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-139980, filed Jul. 15, 2016, which is hereby incorporated by reference herein in its entirety.

What is claimed is:

1. A control apparatus comprising:
a signal acquirer configured to acquire first pair signals for a focus detection from a first area on an image sensor, and second pair signals for a focus detection from a second area on an AF sensor; and
a calculator configured to calculate a defocus amount using the first pair signals or the second pair signals based on the first area on the image sensor and the second area on the AF sensor.

2. The control apparatus according to claim 1, further comprising an area acquirer configured to acquire an object area detected by an object detector,
wherein the calculator calculates the defocus amount using the first pair signals or the second pair signals based on the object area, the first area on the image sensor, and the second area on the AF sensor.

3. The control apparatus according to claim 2, wherein the calculator calculates the defocus amount using the first pair signals acquired from the image sensor where the first area on the image sensor is closer to the object area than the second area on the AF sensor.

4. The control apparatus according to claim 2, wherein the calculator calculates the defocus amount using the second pair signals acquired from the AF sensor where the first area on the image sensor is farther from the object area than the second area on the AF sensor.

5. The control apparatus according to claim 2, wherein the calculator calculates the defocus amount using the first pair signals acquired from the image sensor where the object area is contained in a pixel area that includes the first area on the image sensor.

6. The control apparatus according to claim 2, wherein the calculator calculates the defocus amount using the second pair signals acquired from the AF sensor where the object area is not contained in a pixel area that includes the first area on the image sensor.

7. The control apparatus according to claim 2, wherein the first area on the image sensor is part of a predetermined pixel area on the image sensor determined based on the object area, and
wherein the second area on the AF sensor is one of a plurality of focus detection points on the AF sensor selected based on the object area.

8. An image capturing apparatus comprising:
an image sensor configured to photoelectrically convert an optical image formed by an image capturing optical system, to output an image signal, and to output first pair signals for a focus detection corresponding to light fluxes that have passed different pupil areas in the image capturing optical system;
an AF sensor configured to output second pair signals for a focus detection;
a signal acquirer configured to acquire the first pair signals from a first area on an image sensor, and the second pair signals from a second area on an AF sensor; and
a calculator configured to calculate a defocus amount using the first pair signals or the second pair signals based on the first area on the image sensor and the second area on the AF sensor.

9. The image capturing apparatus according to claim 8, wherein the image sensor includes a plurality of two-dimensionally arranged micro lenses, a plurality of two-dimensionally arranged first photoelectric converters, and a plurality of two-dimensionally arranged second photoelectric converters, a pair of the first photoelectric converter and the second photoelectric converter being provided for each micro lens.

10. The image capturing apparatus according to claim 9, wherein the image sensor is configured to control a first read operation configured to read part of the plurality of two-dimensionally arranged first photoelectric converters and the plurality of two-dimensionally arranged second photoelectric converters for a focus detection, and a second read operation configured to read all of the plurality of first photoelectric converters and the plurality of second photoelectric converters so as to obtain an image.

11. The image capturing apparatus according to claim 10, wherein the image sensor controls the first read operation for each column.

12. The image capturing apparatus according to claim 10, wherein the image sensor controls the first read operation for each row.

13. The image capturing apparatus according to claim 8, wherein the AF sensor includes a pair of photoelectric conversion element rows corresponding to a focus detection point.

14. A control method comprising the steps of:
acquiring first pair signals for a focus detection from a first area on an image sensor, and second pair signals for a focus detection from a second area on an AF sensor; and
calculating a defocus amount using the first pair signals or the second pair signals based on the first area on the image sensor and the second area on the AF sensor.

15. A non-transitory computer-readable storage medium for storing a program that enables a computer to execute a control method,
wherein the control method includes the steps of:
acquiring first pair signals for a focus detection from a first area on an image sensor, and second pair signals for a focus detection from a second area on an AF sensor; and
calculating a defocus amount using the first pair signals or the second pair signals based on the first area on the image sensor and the second area on the AF sensor.
